(19) United States
(12) Patent Application Publication
(10) Pub. No.: US 2025/0144514 A1
(43) Pub. Date: May 8, 2025

(54) METHOD AND APPARATUS FOR MANAGING GAME DATA

(71) Applicant: NEXON KOREA CORPORATION, Seongnam-si (KR)

(72) Inventors: Jun Hyuk LEE, Seongnam-si (KR); Chan Yeon CHO, Seongnam-si (KR)

(21) Appl. No.: 18/939,172

(22) Filed: Nov. 6, 2024

(30) Foreign Application Priority Data
Nov. 8, 2023 (KR) 10-2023-0153928

(51) Int. Cl. A63F 13/35

(52) U.S. Cl. CPC A63F 13/35

(57) ABSTRACT

Provided is a method of managing game data. The method includes obtaining first event data related to a first event having occurred in a game service. The method includes obtaining a first event hash by applying the first event data to a hash function. The method includes obtaining second event data related to a second event having occurred in the game service after the first event. The method includes obtaining a second event hash by applying a combination of the second event data and the first event hash to the hash function.

### CROSS-REFERENCE TO RELATED APPLICATION

This application is based on and claims priority under 35 U.S.C. § 119 to Korean Patent Application No. 10-2023-0153928, filed on Nov. 8, 2023, in the Korean Intellectual Property Office, the disclosure of which is incorporated by reference herein in its entirety.

### BACKGROUND

### Technical Field

The disclosure relates to a method and apparatus for managing game data.

### Description of the Related Art

Blockchains are new storage structures that guarantee integrity of data and provide availability, based on decentralized trust without a centralized trust provider. Blockchains form a chain by connecting small pieces of data called blocks, and the chain is replicated in all nodes participating in a network. Each block is connected to a previous block by using cryptography, and thus, it is very difficult to modify or delete information once it has been recorded. Accordingly, blockchains enable reliable data storage and secure transactions.

Blockchains have been recognized for their high potential in various fields and are used to store general-purpose data, such as documents, drawings, and images. However, when general-purpose data is stored in blockchains, there is a limitation in that scalability is decreased due to an increase in capacity of a ledger shared by participating nodes. To overcome limited capacity of blockchains, data may be stored by being divided into on-chain data stored in a blockchain and off-chain data managed by a centralized system.

Even in a game service, data used by a user may be designed to be divided into on-chain data and off-chain data. Because the user uses the game service in the form in which the on-chain data and the off-chain data are combined, the user may not distinguish between the on-chain data and the off-chain data while using the game service. The high security and transparency expected from blockchains may also be equally required for the off-chain data.

### BRIEF SUMMARY

Provided are a method and apparatus for managing data in a game service, in which off-chain data is managed in the form of storing event-state to guarantee high security and transparency.

Additional aspects will be set forth in part in the description which follows and, in part, will be apparent from the description, or may be learned by practice of the presented embodiments of the disclosure.

According to some embodiments, provided is a method, performed by a game providing apparatus, of managing game data. The method includes obtaining first event data related to a first event having occurred in a game service, obtaining a first event hash by applying the first event data to a hash function, obtaining second event data related to a second event having occurred in the game service after the first event, and obtaining a second event hash by applying a combination of the second event data and the first event hash to the hash function.

According to an embodiment, the obtaining of the first event data may include storing, in a memory, the first event data generated according to the occurrence of the first event, and obtaining the stored first event data from the memory.

According to an embodiment, the first event data and the second event data may each include information about at least one of a change, a name, a type, an identifier, an owner, and an event occurrence date of an object in the game service, the object being affected by an event occurrence.

According to an embodiment, the combination of the second event data and the first event hash may be determined by a sequential input of the second event data and the first event hash.

According to an embodiment, the method may further include obtaining first state data related to a first state that is a result according to the occurrence of the first event, and obtaining a first state hash by applying a combination of the first state data and the first event hash to the hash function.

According to an embodiment, the method may further include obtaining second state data related to a second state that is a result according to the occurrence of the second event, and obtaining a second state hash by applying a combination of the second state data and the second event hash to the hash function. The second event hash may be obtained by applying a combination of the second event data and the first event hash to the hash function.

According to an embodiment, the method may further include obtaining, from a memory, a first hash value corresponding to the second event hash, obtaining, from the memory, the second event data and the first event hash, calculating a second hash value corresponding to the second event hash by applying the combination of the second event data and the first event hash to the hash function, comparing the first hash value with the second hash value, and verifying the sequentiality of the first event hash and the second event hash, based on a result of the comparing.

According to an embodiment, the method may further include, when the first hash value and the second hash value do not match each other, based on the result of the comparing, reobtaining the first event data from the memory, reobtaining the first event hash by applying the first event data to the hash function, reobtaining the second event data from the memory, reobtaining the second event hash by applying a combination of the reobtained second event data and the reobtained first event hash to the hash function, and updating the memory based on the reobtained first event hash and the reobtained second event hash.

According to an embodiment, the method may further include obtaining, from a memory, a third hash value corresponding to the first state hash, obtaining, from the memory, the first state data and the first event hash, obtaining a fourth hash value corresponding to the first event hash by applying the combination of the first state data and the first event hash to the hash function, comparing the third hash value with the fourth hash value, and verifying the causality of the first event hash and the first state hash, based on a result of the comparing.

According to an embodiment, the method may further include, according to the third hash value and the fourth hash value not corresponding to each other, based on the result of the comparing, reobtaining the first event data from the memory, reobtaining the first event hash by applying the first event data to the hash function, reobtaining the first state data from the memory, reobtaining the first event hash by applying a combination of the reobtained first event data and the reobtained first event hash to the hash function, and updating the memory based on the reobtained first state hash.

According to some embodiments, provided is a method, performed by a game providing apparatus, of managing game data. The method includes obtaining first event data related to a first event having occurred in a game service, and first state data related to a first state that is a result according to the occurrence of the first event, obtaining a first event hash by applying the first event data to a hash function, and obtaining a first state hash by applying a combination of the first state data and the first event hash to the hash function.

According to some embodiments, a game providing apparatus includes a memory storing instructions, and at least one processor functionally connected to the memory and configured to execute the instructions to obtain first event data related to a first event having occurred in a game service, obtain a first event hash by applying the first event data to a hash function, obtain second event data related to a second event having occurred in the game service after the first event, and obtain a second event hash by applying a combination of the second event data and the first event hash to the hash function.

According to an embodiment, the first event data and the second event data may each include information about at least one of a change, a name, a type, an identifier, an owner, and an event occurrence date of an object in the game service, the object being affected by an event occurrence.

According to an embodiment, the at least one processor may be further configured to execute the instructions to obtain first state data related to a first state that is a result according to the occurrence of the first event, and obtain a first state hash by applying a combination of the first state data and the first event hash to the hash function.

According to an embodiment, the at least one processor may be further configured to execute the instructions to obtain second state data related to a second state that is a result according to the occurrence of the second event, and obtain a second state hash by applying a combination of the second state data and the second event hash to the hash function, wherein the second event hash may be obtained by applying a combination of the second event data and the first event hash to the hash function.

According to an embodiment, the at least one processor may be further configured to execute the instructions to obtain, from the memory, a first hash value corresponding to the second event hash, obtain, from the memory, the second event data and the first event hash, calculate a second hash value corresponding to the second event hash by applying the combination of the second event data and the first event hash to the hash function, compare the first hash value with the second hash value, and verify the sequentiality of the first event hash and the second event hash, based on a result of the comparison.

According to an embodiment, according to the first hash value and the second hash value not corresponding to each other, based on the result of the comparison, the at least one processor may be further configured to execute the instructions to reobtain the first event data from the memory, reobtain the first event hash by applying the first event data to the hash function, reobtain the second event data from the memory, reobtain the second event hash by applying a combination of the reobtained second event data and the reobtained first event hash to the hash function, and update the memory based on the reobtained first event hash and the reobtained second event hash.

According to an embodiment, the at least one processor may be further configured to execute the instructions to obtain, from the memory, a third hash value corresponding to the first state hash, obtain, from the memory, the first state data and the first event hash, obtain a fourth hash value corresponding to the first event hash by applying the combination of the first state data and the first event hash to the hash function, compare the third hash value with the fourth hash value, and verify the causality of the first event hash and the first state hash, based on a result of the comparison.

According to an embodiment, when the third hash value and the fourth hash value do not match each other, based on the result of the comparison, the at least one processor may be further configured to execute the instructions to reobtain the first event data from the memory, reobtain the first event hash by applying the first event data to the hash function, reobtain the first state data from the memory, reobtain the first event hash by applying a combination of the reobtained first event data and the reobtained first event hash to the hash function, and update the memory based on the reobtained first state hash.

According to some embodiments, a server includes a memory storing instructions, and at least one processor functionally connected to the memory and configured to execute the instructions to obtain first event data related to a first event having occurred in a game service, obtain a first event hash by applying the first event data to a hash function, obtain second event data related to a second event having occurred in the game service after the first event, and obtain a second event hash by applying a combination of the second event data and the first event hash to the hash function.

According to some embodiments, a user terminal for providing a game service, includes a user input unit configured to receive a user input, a memory storing instructions, and at least one processor functionally connected to the user input unit and the memory, and configured to execute the instructions to obtain first event data related to a first event having occurred in the game service, obtain a first event hash by applying the first event data to a hash function, obtain second event data related to a second event having occurred in the game service after the first event, and obtain a second event hash by applying a combination of the second event data and the first event hash to the hash function.

According to some embodiments, a computer-readable recording medium has recorded thereon a program for executing, on a computer, a method of managing game data, the method including obtaining first event data related to a first event having occurred in a game service, obtaining a first event hash by applying the first event data to a hash function, obtaining second event data related to a second event having occurred in the game service after the first event, and obtaining a second event hash by applying a combination of the second event data and the first event hash to the hash function.

### BRIEF DESCRIPTION OF THE SEVERAL VIEWS OF THE DRAWINGS

The above and other aspects, features, and advantages of certain embodiments of the disclosure will be more apparent from the following description taken in conjunction with the accompanying drawings, in which:

FIG. 1 illustrates a game providing system including a server and a user terminal, according to some embodiments;

FIG. 2 is a conceptual diagram for describing a method of managing off-chain data related to an event, according to an embodiment;

FIG. 3 is a flowchart of a method of managing off-chain data related to an event, according to an embodiment;

FIG. 4 is a conceptual diagram for describing a relationship between an event and a state, according to an embodiment;

FIG. 5 is a diagram for describing a method of managing off-chain data related to a state, according to an embodiment;

FIG. 6 is a diagram for describing a method of verifying the sequentiality of events based on stored off-chain data, according to an embodiment;

FIG. 7 is a flowchart of a method of verifying the sequentiality of events based on stored off-chain data, according to an embodiment;

FIG. 8 is a flowchart of a method of recovering data when an event has been falsified, according to an embodiment;

FIG. 9 is a conceptual diagram for describing a memory storing off-chain data, according to an embodiment;

FIG. 10 is a diagram for describing a method of verifying the causality between an event and a state, based on stored off-chain data, according to an embodiment;

FIG. 11 is a flowchart of a method of verifying the causality between an event and a state, based on stored off-chain data, according to an embodiment;

FIG. 12 is a flowchart of a method of recovering data when an event or a state has been falsified, according to an embodiment;

FIG. 13 is a diagram for describing a specific configuration of a game providing apparatus, according to some embodiments;

FIG. 14 is a diagram for describing a specific configuration of a server, according to some embodiments; and

FIG. 15 is a diagram for describing a specific configuration of a user terminal, according to some embodiments.

### DETAILED DESCRIPTION

Hereinafter, embodiments will be described in detail with reference to content shown in accompanying drawings. Also, methods of configuring and using a game providing apparatus according to an embodiment will be described in detail with reference to the content shown in the accompanying drawings. Like reference numerals or signs in the drawings denote parts or components substantially performing same functions.

While terms including ordinal numbers, such as “first,” “second,” etc., may be used to describe various components, such components are not limited to the above terms. The above terms are used only to distinguish one element from another. For example, without departing from the scope of the rights described in the disclosure, a first component may be referred to as a second component, and similarly, a second component may be referred to as a first component. The term “and/or” includes a combination of a plurality of related items or one item from among the plurality of related items. Expressions such as “at least one of,” when preceding a list of elements, modify the entire list of elements and do not modify the individual elements of the list.

Also, the terms used in the present specification are only used to describe embodiments, and are not intended to limit and/or restrict the disclosure. Singular expressions include plural expressions unless the context clearly indicates otherwise. In the present specification, it is to be understood that terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Throughout the specification, when a part is “connected” to another part, the part may not only be “directly connected” to the other part, but may also be “electrically connected” to the other part with another element in between. In addition, when a part “comprises (includes)” a certain element, the part may further include another element instead of excluding the other element, unless otherwise stated. In addition, terms such as “unit,” “-or/-er,” and “module” described in the specification denote a unit that processes at least one function or operation, which may be implemented in hardware or software, or implemented in a combination of hardware and software.

A game providing apparatus of the disclosure below may be a game server, a user terminal, a game system including the game server and the user terminal, or an independent apparatus.

In the disclosure below, a server controlling a user terminal may indicate that the server communicates with the user terminal to provide an output (any output device in the user terminal, such as screen display, sound output, vibration output, and lamp illumination) of the user terminal and provide data for the user terminal to perform a certain operation. Obviously, the user terminal may control an output of the user terminal by using pre-stored data and the disclosure is not limited to the above examples.

In the disclosure below, transmitting and receiving information or data with a user (or a user account) may indicate that information or data is transmitted and received to and from a device (or a user terminal) corresponding to or linked to the user (or the user account).

In the disclosure below, a blockchain may denote a distributed peer to peer (P2P) system of a ledger, which uses a software element including an algorithm in which sequentially connected blocks negotiate transaction information by using an encryption technique and security technology to secure and maintain integrity. Here, the distributed P2P system may be in a special form of a distributed system. Also, in the P2P system, all nodes in a network may provide resources (processing capability, a storage space, data or a network bandwidth) to each other without coordination of a center node. In addition, the blockchain may denote a distributed ledger technology in which a ledger recorded with transaction information is distributed in a P2P network instead of a center server of a specific institute for nodes in a network jointly record and manage the ledger.

In the disclosure below, a user, a player, a user account, and a gamer may be used in a same meaning. In the disclosure, it should be understood that a user terminal may indicate a user, a player, a user account, or a gamer, or a device used by the user, the player, the user account, or the gamer, according to context. In the disclosure, it should be understood that a user, a player, a user account, or a gamer may indicate an avatar or a character manipulated by the user, the player, the user account, or the gamer, or a device used by the user, the player, the user account, or the gamer, according to context.

In the present specification below, an object may denote not only a background, a geographical feature, a character, or a weapon, but also an aiming point, a physical strength interface, or anything displayed on a game execution screen. In particular, an object may denote an object related to game content available to a user. Examples of an object may include an item object, a region object defining a specific region, a structure object such as a building, and a non-player character (NPC) object, but are not limited thereto.

In the disclosure below, an item may include any of objects, goods, and content, and may denote any piece of digital content or cyber object obtainable by a user in a game, for example, equipment worn by an in-game character, such as a weapon, armor, clothes, or a crystal, a transportation means ridden by an in-game character, consumable such as food or portion, an experience point, or a buff. However, the item is not limited thereto.

In the disclosure below, an event may denote a change that may occur for at least one object in a game service. Examples of an event may include changes related to various objects in a game, such as an owner change of a first item, a strengthening attempt (success or failure), a transaction, acquisition, disassembly, and generation, deletion, name change, level-up, level-down, and movement of a first character.

In the disclosure below, a state may denote a state of at least one object, which is determined according to the occurrence of an event. For example, when an event of an owner change of a first item has been generated, a state may include information about a current owner of the first item. A state may be a result determined with an event as a cause.

In the disclosure below, a hash function may denote a function that converts any form of data into numbers of a fixed length regardless of a length of input data. A hash function may calculate a hash value by using bits and bytes, which configure input data.

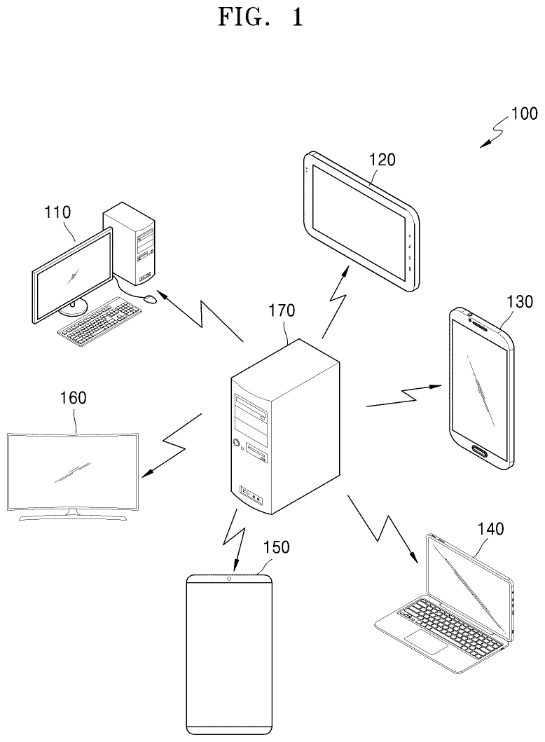

FIG. 1 illustrates a game providing system 100 including a server 170 and a user terminal, according to some embodiments.

The game providing system 100 of the disclosure may include the server 170 and at least one of user terminals 110 to 160. The server 170 may provide various online activities through a network. The server 170 may provide an online activity simultaneously to at least one of the user terminals 110 to 160.

According to an embodiment, the server 170 may include a single server, an array of servers, or a cloud server, but is not limited thereto. The server 170 provides various online activities and may include a database storing data for the online activities. Also, the server 170 may include a payment server configured to generate and process a payment event. As described above, the server 170 may be a game providing apparatus.

According to an embodiment, a network denotes connection established (or formed) by using any communication method, and may indicate a communication network connected through any communication method, which transmits and receives data between terminals or between a terminal and a server.

Any communication method may include all communication methods, such as communication through a certain communication standard, a certain frequency band, a certain protocol, and a certain channel. For example, any communication method may include communication methods through Bluetooth, Bluetooth low energy (BLE), Wi-Fi, ZigBee, 3rd generation (3G), long-term evolution (LTE), and ultrasonic waves, and may include all of short-range communication, long-range communication, wireless communication, and wired communication. However, the communication method is not limited to the above examples.

According to an embodiment, a short-range communication method may denote a communication method in which communication is possible only when a device (a terminal or a server) performing communication is within a specific range, and may include, for example, Bluetooth or near field communication (NFC). A long-range communication method may denote a communication method in which a device performing communication is able to perform communication regardless of a distance. For example, the long-range communication method may denote a method by which two devices performing communication through a relay, such an access point (AP), perform communication even when the two devices are separated by a certain distance or greater, and may include a communication method using a cellular network (3G or LTE), such as a short message service (SMS) or a phone call. However, the long-range communication method is not limited to the above examples. Receiving of an online activity by using a network may indicate that communication may be performed between a server and a terminal through any communication method.

Throughout the specification, at least one of the user terminals 110 to 160 may include not only a personal computer (PC) 110, a tablet PC 120, a cellular phone 130, a laptop computer 140, a smartphone 150, and a television (TV) 160, but also various electronic devices, such as a personal digital assistant (PDA), a portable multimedia player (PMP), a navigation device, an MP3 player, a digital camera, a refrigerator, a washing machine, and a vacuum cleaner, but is not limited thereto. As described above, at least one of the user terminals 110 to 160 may be the game providing apparatus.

According to an embodiment, the online activity may include an online game, a portal service, or a social network service (SNS), but is not limited thereto. Also, the online game may include any genre, such as massive multi-user online role playing game (MMORPG), aeon of strife (AOS), first person shooter (FPS), trading card game (TCG), or collectible card game (CCG). The online game may be a game pitting users against each other or a game pitting a user against a computer (e.g., artificial intelligence). Obviously, the online game is not limited thereto, and a type of the online game is not limited.

The game providing system 100 according to an embodiment may provide a method of managing game data. The game providing system 100 may obtain first event data related to a first event having occurred in a game service. The game providing system 100 may obtain a first event hash by applying the first event data to a hash function. The game providing system 100 may obtain second event data related to a second event having occurred in the game service after the first event. The game providing system 100 may obtain a second event hash by applying a combination of the second event data and the first event hash to the hash function.

According to an embodiment, at least one of the user terminals 110 to 160 may obtain a user input for generating the first event. At least one of the user terminals 110 to 160 may obtain the first event data, based on the obtained user input.

The server 170 may obtain the first event data from at least one of the user terminals 110 to 160. The server 170 may obtain the first event hash by applying the first event data to the hash function.

According to an embodiment, at least one of the user terminals 110 to 160 may obtain a user input for generating the second event. The second event may be an event having occurred after the first event. At least one of the user terminals 110 to 160 may obtain the second event data, based on the obtained user input.

The server 170 may obtain the second event data from at least one of the user terminals 110 to 160. The server 170 may obtain the second event hash by applying the combination of the second event data and the first event hash to the hash function. The server 170 may store the obtained first event hash and second event hash.

The game providing system 100 according to an embodiment may obtain the first event data related to the first event having occurred in the game service, and first state data related to a first state that is a result according to the occurrence of the first event. The game providing system 100 may obtain the first event hash by applying the first event data to the hash function. The game providing system 100 may obtain a first state hash by applying a combination of the first state data and the first event hash to the hash function.

According to an embodiment, at least one of the user terminals 110 to 160 may obtain the user input for generating the first event. At least one of the user terminals 110 to 160 may obtain the first event data, based on the obtained user input.

The server 170 may obtain the first event data from at least one of the user terminals 110 to 160. The server 170 may obtain the first event hash by applying the first event data to the hash function. The server 170 may obtain the first state data based on a result of reproducing the first event data. The server 170 may obtain the first state hash by applying the combination of the first state data and the first event hash to the hash function.

According to an embodiment, some or all of operations of the server 170 may be performed by the user terminals 110 to 160. For example, according to some embodiments, a method of providing a game service may be performed by the user terminals 110 to 160 without communication with the server 170.

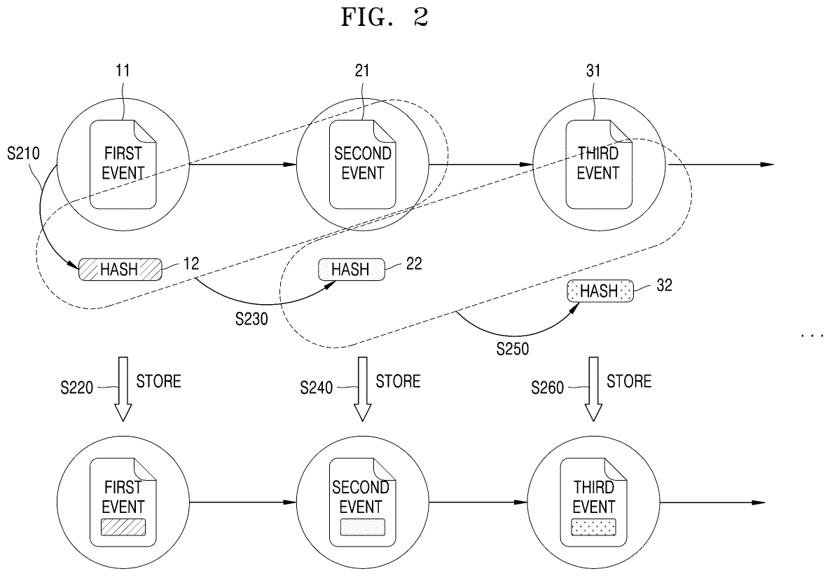

FIG. 2 is a conceptual diagram for describing a method of managing off-chain data related to an event, according to an embodiment.

Referring to FIG. 2, according to an embodiment, an event hash may be calculated in consideration of an event hash for a previous event.

According to an embodiment, a first event to a third event may occur in a game service. The first event to the third event may denote events that occur sequentially with the lapse of time. For convenience of description, FIG. 2 illustrates the first event to the third event, but the number of events does not limit the technical scope of the disclosure.

According to an embodiment, events including the first event to the third event may indicate changes generated in at least one object in the game service. For example, the first event may denote success on a first strengthening attempt for a first item, the second event may denote failure on a second strengthening attempt for the first item, and the third event may denote success on a third strengthening attempt for the first item. Examples of the events do not limit the technical scope of the disclosure.

According to an embodiment, a game providing apparatus may obtain event data according to the occurrence of an event. The game providing apparatus may obtain first event data 11 according to the occurrence of the first event, second event data 21 according to the occurrence of the second event, and third event data 31 according to the occurrence of the third event.

According to an embodiment, event data may include information about a change in at least one object, generated according to an event. For example, the event data may each include information about at least one of a change, a name, a type, an identifier, an owner, and an event occurrence date of at least one object in a game service, the at least one object being affected by an event occurrence.

In detail, for example, an event indicating that an item called “hand axe” has been successfully strengthened may occur. In relation to the occurred event, the game providing apparatus may obtain event data about an item name (hand axe), a change (strengthened value of target item: +1), a type of a target item (weapon), and an owner.

In operation S210, the game providing apparatus may obtain a first event hash 12 based on the first event data 11. According to an embodiment, the game providing apparatus may obtain the first event hash 12 by applying the first event data 11 to a hash function.

According to an embodiment, the game providing apparatus may obtain the first event hash 12 by using the hash function with a list of values of pieces of information included in the first event data 11 as input values. For example, the hash function may include a SHA-256 algorithm, but a type of the hash function does not limit the technical scope of the disclosure.

For example, the first event data 11 may include information about an item name (hand axe), a strengthening attempt (2→3), and whether the strengthening attempt is successful (failed). The game providing apparatus may obtain the first event hash 12 of “81139A0FE1A80199CC7A8E7C8C72BA47A90CA117DBF8E193CF03C8706B343055” by using the hash function with “hand axe 2→3 failed” as an input value.

In operation S220, the game providing apparatus may store the first event data 11 and the first event hash 12 together.

For example, the game providing apparatus may generate the first event hash 12 based on the first event data 11 and append the first event hash 12 to the first event data 11. The game providing apparatus may store the first event data 11 including the first event hash 12. However, for convenience of description, in the disclosure, the first event data 11 and the first event hash 12 may be distinguishably described.

In operation S230, the game providing apparatus may obtain a second event hash 22 in consideration of the first event hash 12.

According to an embodiment, the game providing apparatus may obtain the second event data 21 related to the second event having occurred in the game service. The second event may be an event having occurred after the first event with the lapse of time.

According to an embodiment, the game providing apparatus may obtain the second event hash 22 by applying a combination of the second event data 21 and the first event hash 12 to the hash function. According to an embodiment, the game providing apparatus may obtain the second event hash 22 by using the hash function with a list of values of pieces of information included in the second event data 21 and the first event hash 12, as input values. The combination of the second event data 21 and the first event hash 12 may be determined by a sequential input of the second event data 21 and the first event hash 12.

For example, the second event data 21 may include information about an item name (hand axe), a strengthening attempt (2→3), and whether the strengthening attempt is successful (successful). As described above in operation S210, the first event hash 12 may be “81139A0FE1A80199CC7A8E7C8C72BA47A90CA117DBF8E193CF03C8706B343055”. The game providing apparatus may obtain the second event hash 22 “ADOF01DC0FD3CFA821AF173192FC339A6110625E51B91C0C616EAB526C071B6A” by using the hash function with “hand axe 2→3 successful 81139A0FE1A80199CC7A8E7C8C72BA47A90CA117DBF8E193CF03C8706B343055” as an input value.

In operation S240, the game providing apparatus may store the second event data 21 and the second event hash 22 together. Descriptions of operation S240 overlap those of operation S220, and thus are not provided.

In operation S250, the game providing apparatus may obtain a third event hash 32 in consideration of the second event hash 22.

According to an embodiment, the game providing apparatus may obtain the third event data 31 related to the third event having occurred in the game service. The third event may be an event having occurred after the second event with the lapse of time.

According to an embodiment, the game providing apparatus may obtain the third event hash 32 by applying a combination of the third event data 31 and the second event hash 22 to the hash function. According to an embodiment, the game providing apparatus may obtain the third event hash 32 by using the hash function with a list of values of pieces of information included in the third event data 31 and the second event hash 22, as input values.

In operation S260, the game providing apparatus may store the third event data 31 and the third event hash 32 together. Descriptions of operation S260 overlap those of operation S220, and thus are not provided.

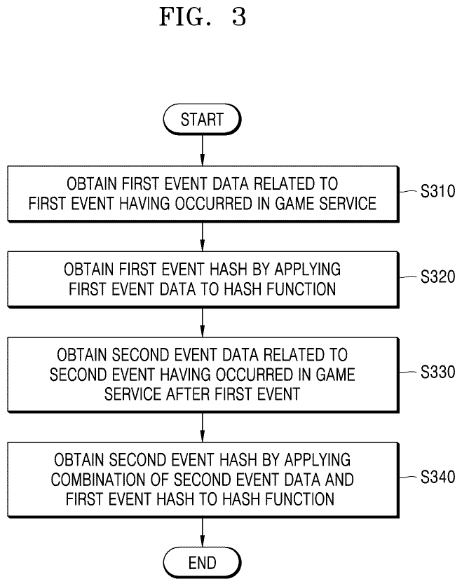

FIG. 3 is a flowchart of a method of managing off-chain data related to an event, according to an embodiment. For convenience of description, details that overlap those described with reference to FIG. 2 will be briefly described or not be provided.

Referring to FIG. 3, in operation S310, the game providing apparatus may obtain first event data related to a first event having occurred in a game service.

According to an embodiment, the game providing apparatus may obtain a user input that is to generate the first event. The game providing apparatus may be a user terminal and obtain the user input directly, or may receive the user input from a user terminal. The technical scope of the disclosure is not limited thereto. The game providing apparatus may obtain the first event data based on the obtained user input.

According to an embodiment, the first event data may include information about the occurrence of an event and corresponding changes, such as a change, a name, a type, an identifier, an owner, and an event occurrence date of an object in the game service, the object being affected by an event occurrence.

In operation S320, the game providing apparatus may obtain a first event hash by applying the first event data to a hash function.

According to an embodiment, the game providing apparatus may obtain, as input values, a list of values of pieces of information included in the first event data. The game providing apparatus may obtain the first event hash by applying the obtained input values to the hash function. However, a listing method is only an example and a method of obtaining input values that are applied to a hash function is not limited to the listing method.

In operation S330, the game providing apparatus may obtain second event data related to a second event having occurred in the game service after the first event.

According to an embodiment, the game providing apparatus may obtain a user input that is to generate the second event. The game providing apparatus may be a user terminal and obtain the user input directly, or may receive the user input from a user terminal. The technical scope of the disclosure is not limited thereto.

According to an embodiment, the second event data may include information about the occurrence of an event and corresponding changes, such as a change, a name, a type, an identifier, an owner, and an event occurrence date of an object in the game service, the object being affected by an event occurrence.

In operation S340, the game providing apparatus may obtain a second event hash by applying a combination of the second event data and the first event hash to the hash function.

According to an embodiment, the game providing apparatus may obtain, as input values, a list of values of pieces of information included in the second event data and the first event hash. The game providing apparatus may obtain the second event hash by applying the obtained input values to the hash function. However, a listing method is only an example and a method of obtaining input values that are applied to a hash function is not limited to the listing method.

The game providing apparatus according to various embodiments provides a method of generating and managing an event hash so that the sequentiality between events is verifiable. Because the event hashes for the events are generated in consideration of an event hash of an event having occurred before, the sequentiality between the events may be verified. The game providing apparatus may provide a game service with higher security and transparency and enable users to identify the sequentiality of events, and thus, reliability of the game providing apparatus may be improved.

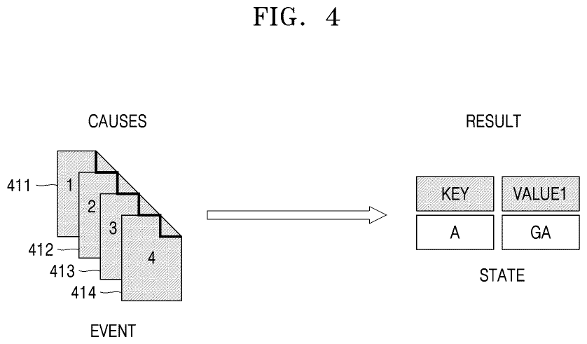

FIG. 4 is a conceptual diagram for describing a relationship between an event and a state, according to an embodiment.

Referring to FIG. 4, an event may correspond to causes and a state may correspond to a result. A state may denote a state generated by an event.

According to an embodiment, a first event may occur in a game service. The game providing apparatus may obtain a change in at least one object according to the first event. The game providing apparatus may obtain the change in the at least one object according to reproduction of the first event, and record a current state considering the obtained change as a state.

According to an embodiment, a second event may occur in the game service after the first event. The game providing apparatus may obtain a change in at least one object according to the second event. The game providing apparatus may obtain the change in the at least one object according to reproduction of the second event, and record a current state considering the obtained change as a state.

According to an embodiment, the game providing apparatus may update a current state as a state whenever each event occurs. The game providing apparatus may store event data and an event hash for each event and store state data and a state hash for a current state.

In FIG. 4, a key and a value 1 are illustrated as state data. The key may denote an identifier of an item. For example, the key may be a value for referring to a specific item through a type of an item and an identification address of the item. The value 1 is illustrated as an example and general information indicating states of the item, such as a strengthening level, an owner, a generated date, may be included.

According to an embodiment, a first event 411, a second event 412, a third event 413, and a fourth event 414 may occur in relation to the first item. For example, the first event 411, the second event 412, the third event 413, and fourth event 414 may indicate strengthening attempts for the first item.

The first event 411 may be a strengthening success event for the first item. The game providing apparatus may update the state based on the first event 411. “A” recorded in the key may be an identifier referring to the “first item that has been successfully strengthened once” and “+1” that is a strengthening level may be recorded as an example of the value 1.

The second event 412 may occur after the first event 411. The second event 412 may be a strengthening failure event for the first item. The game providing apparatus may update the state based on the second event 412. “A” recorded in the key may be an identifier referring to the “first item that has been successfully strengthened once” and “+1” that is a strengthening level may be recorded as an example of the value 1. According to an embodiment, the state may not change according to content of an event.

The third event 413 may occur after the second event 412. The third event 413 may be a strengthening success event for the first item. The game providing apparatus may update the state based on the third event 413. “A” recorded in the key may be an identifier referring to the “first item that has been successfully strengthened two times” and “+2” that is a strengthening level may be recorded as an example of the value 1.

The game providing apparatus may update the state based on the fourth event 414 in the same manner. Related descriptions overlap those of the first event 411, the second event 412, and the third event 413, and are not provided.

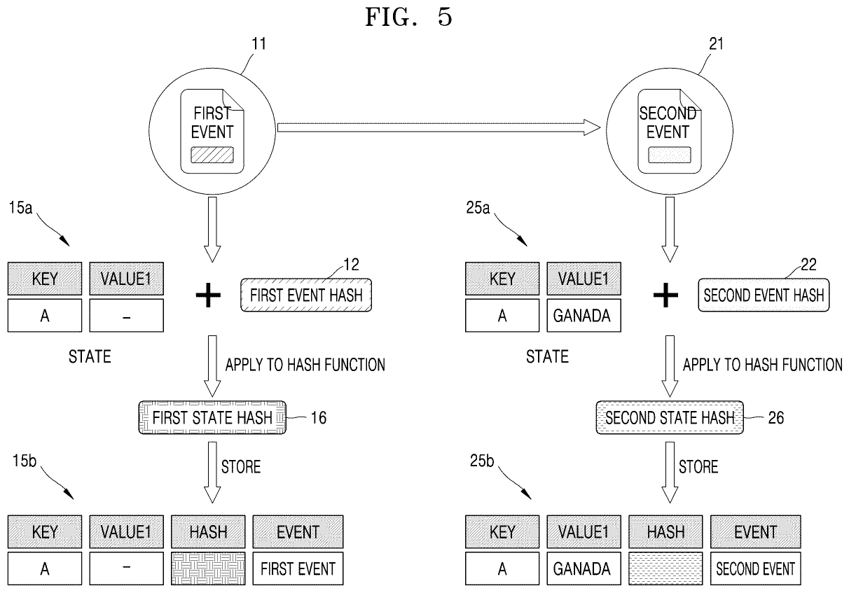

FIG. 5 is a diagram for describing a method of managing off-chain data related to a state, according to an embodiment. For convenience of description, details that overlap those described with reference to FIG. 2 will be briefly described or not be provided.

Referring to FIG. 5, according to an embodiment, a state hash may be calculated in consideration of an event hash.

According to an embodiment, the first event may occur in a game service. The game providing apparatus may obtain the first event data 11 according to the occurrence of the first event, and obtain the first event hash 12 based on the first event data 11.

For example, the game providing apparatus may obtain the first event hash 12 by applying the first event data 11 to the hash function. In another example, the game providing apparatus may obtain the first event hash 12 stored in a memory.

According to an embodiment, the game providing apparatus may obtain first state data 15a updated based on the occurrence of the first event. For example, as shown in FIG. 5, “A” may be recorded in a key and “null” may be recorded in a value 1, based on the occurrence of the first event. The first state data 15a may be recorded with “A” for a value of the key and “null” for the value 1.

According to an embodiment, the game providing apparatus may obtain a first state hash 16 considering the first state data 15a and the first event hash 12. The game providing apparatus may obtain the first state hash 16 by applying a combination of the first state data 15a and the first event hash 12 to the hash function.

According to an embodiment, the game providing apparatus may obtain the first state hash 16 by using the hash function with a list of values of pieces of information included in the first state data 15a and the first event hash 12, as input values. The combination of the first state data 15a and the first event hash 12 may be determined by a sequential input of the first state data 15a and the first event hash 12.

For example, the first state data 15a may include information about the key (A) and the value 1 (null). As described above in operation S210 of FIG. 2, the first event hash 12 may be “81139A0FE1A80199CC7A8E7C8C72BA47A90CA117DBF8E193CF03C8706B343055”. The game providing apparatus may obtain the first state hash 16 of “887D855D377F1CD0F0F9667183201CC5AA153D045006A690F67D2FACA71734FB” by using the hash function with “Anull81139A0FE1A80199CC7A8E7C8C72BA47A90CA117DBF8E193CF03C8706B343055” as the input values.

According to an embodiment, the game providing apparatus may store the first state data 15a and the first state hash 16 together.

For example, the game providing apparatus may generate the first state hash 16 based on the first state data 15a and the first event hash 12, and append the first state hash 16 to first state data 15b. The game providing apparatus may store the first state data 15b including the first state hash 16. However, for convenience of description, in the disclosure, the first state data 15a and the first state hash 16 may be distinguishably described.

Similarly, according to an embodiment, the second event may occur in the game service. The second event may occur after the first event. The game providing apparatus may obtain the second event data 21 according to the occurrence of the second event, and obtain the second event hash 22 based on the second event data 21.

For example, the game providing apparatus may obtain the second event hash 22 by applying the second event data 21 to the hash function. In another example, the game providing apparatus may obtain the second event hash 22 stored in the memory.

According to an embodiment, the game providing apparatus may obtain the second event hash 22 based on not only the second event data 21, but also the first event hash 12. The game providing apparatus may obtain the second event hash 22 by applying the combination of the second event data 21 and the first event hash 12 to the hash function.

According to an embodiment, the game providing apparatus may obtain second state data 25a updated based on the occurrence of the second event. For example, as shown in FIG. 5, “A” may be recorded in a key and “Ganada” may be recorded in a value 1, based on the occurrence of the second event. The second state data 25a may be recorded with “A” for a value of the key and “Ganada” for the value 1.

According to an embodiment, the game providing apparatus may obtain a second state hash 26 considering the second state data 25a and the second event hash 22. The game providing apparatus may obtain the second state hash 26 by applying a combination of the second state data 25a and the second event hash 22 to the hash function.

According to an embodiment, the game providing apparatus may store the second state data 25a and the second state hash 26 together. For example, the game providing apparatus may generate the second state hash 26 based on the second state data 25a and the second event hash 22, and append the second state hash 26 to second state data 25b. The game providing apparatus may store the second state data 25b including the second state hash 26.

For convenience of description, an operation of obtaining the second state hash 26 is the same as an operation of obtaining the first state hash 16, and redundant description is briefly described.

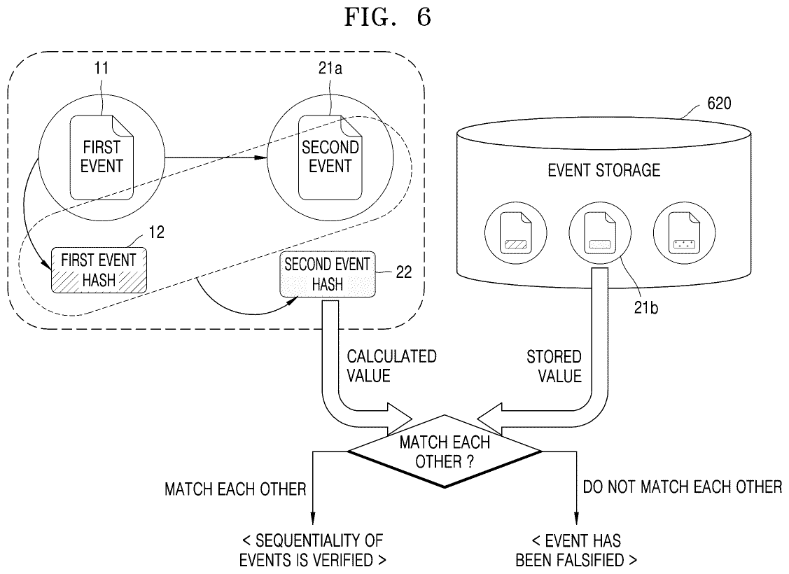

FIG. 6 is a diagram for describing a method of verifying the sequentiality of events based on stored off-chain data, according to an embodiment. For convenience of description, details that overlap those described with reference to FIG. 2 are not be provided.

Referring to FIG. 6, according to an embodiment, the game providing apparatus may verify the sequentiality of events by verifying that an event hash has not been falsified.

According to an embodiment, the game providing apparatus may obtain an event hash for each occurred event. The game providing apparatus may calculate a value corresponding to an event hash to be compared with, to verify the sequentiality of events.

For example, the first event and the second event may occur in the game service. The first event and the second event may be events that occur sequentially with the lapse of time.

The game providing apparatus may obtain the first event hash 12 based on the first event data 11 related to the first event. The game providing apparatus may calculate the first event hash 12 by applying the first event data 11 to the hash function.

The game providing apparatus may obtain the second event hash 22 based on the first event hash 12 and second event data 21a related to the second event. The game providing apparatus may calculate the second event hash 22 by applying the combination of the second event data 21a and the first event hash 12 to the hash function. The game providing apparatus may calculate the second event hash 22 by applying listed values of the second event data 21a and the first event hash 12 to the hash function.

According to an embodiment, the game providing apparatus may obtain, from the memory, a stored event hash value that is to be compared with to verify the sequentiality of events. The stored event hash value may be a value stored in the memory during event occurrence. For example, the game providing apparatus may obtain the second event hash 22 from the memory.

According to an embodiment, the memory may include an event storage 620. The event storage 620 may be a memory region storing an event having occurred in the game service. Event data may be only appended and read from the event storage 620, and may be unable to be changed and deleted from the event storage 620. For example, the game providing apparatus may continuously store event data in the event storage 620 and read the stored event data, but may not be able to change and delete the stored event data.

According to an embodiment, the game providing apparatus may obtain a stored second event hash from the event storage 620. The stored second event hash may be a hash value stored together with second event data 21b.

According to an embodiment, the game providing apparatus may compare the calculated second event hash with the stored second event hash. The game providing apparatus may verify the sequentiality of the first event hash 12 and the second event hash 22, based on a result of the comparison.

According to an embodiment, when the calculated second event hash and the stored second event hash match each other, the game providing apparatus may determine that the sequentiality of the first event hash 12 and the second event hash 22 are verified. The game providing apparatus may determine that falsification has not occurred according to an order of the first event and the second event, and the second event hash 22 is appropriately stored without falsification.

According to an embodiment, when the calculated second event hash and the stored second event hash do match each other, the game providing apparatus may determine that the sequentiality of the first event hash 12 and the second event hash 22 are not verified. The game providing apparatus may determine that falsification has occurred according to an order of the first event and the second event, and the second event hash 22 has been falsified and inappropriately stored.

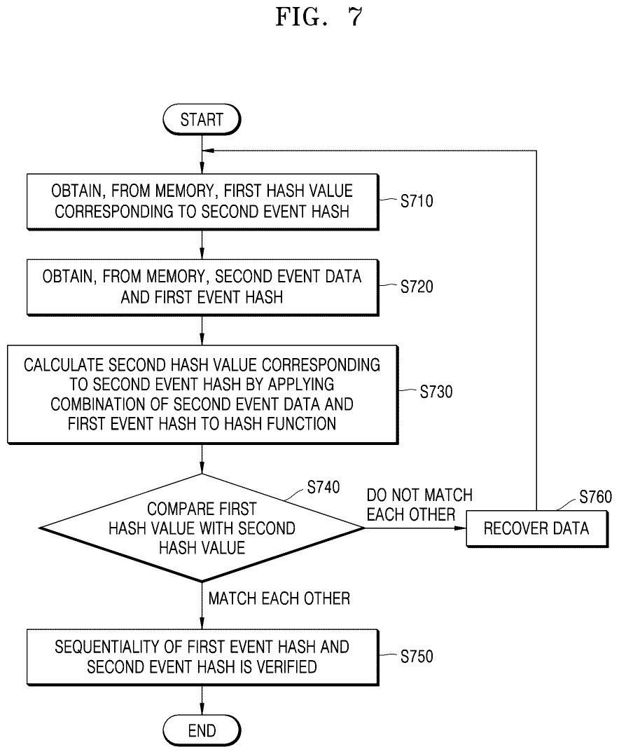

FIG. 7 is a flowchart of a method of verifying the sequentiality of events based on stored off-chain data, according to an embodiment; For convenience of description, details that overlap those described with reference to FIG. 6 will be briefly described or not be provided.

Referring to FIG. 7, in operation S710, the game providing apparatus may obtain, from the memory, a first hash value corresponding to a second event hash.

According to an embodiment, the game providing apparatus may generate the second event hash based on second event data and a first event hash when a second event occurs, and store the second event hash in the memory. The game providing apparatus may obtain the first hash value corresponding to the second event hash pre-stored in the memory.

According to an embodiment, the second event hash may be calculated by applying a combination of the second event data and the first event hash to a hash function.

In operation S720, the game providing apparatus may obtain, from the memory, the second event data and the first event hash. The game providing apparatus may obtain the second event data and the first event hash, which are pre-stored in the memory.

In operation S730, the game providing apparatus may calculate a second hash value corresponding to the second event hash by applying the combination of the second event data and the first event hash to the hash function. The game providing apparatus may recalculate the second event hash based on the combination of the second event data and the first event hash, stored in the memory.

In operation S740, the game providing apparatus may compare the first hash value with the second hash value.

According to an embodiment, the first hash value may be a value corresponding to the second event hash stored in the memory. The game providing apparatus may obtain, from the memory, the first hash value corresponding to the stored second event hash.

According to an embodiment, the second hash value may be a value of the second event hash recalculated based on the second event data and the first event hash, stored in the memory. The game providing apparatus may obtain, from the memory, the stored second event data and first event hash, and recalculate the second event hash based on the second event data and the first event hash.

According to an embodiment, the game providing apparatus may compare the stored first hash value with the recalculated second hash value. The game providing apparatus may determine whether the first hash value and the second hash value match each other.

When the first hash value and the second hash value match each other, the game providing apparatus may determine that the sequentiality of the first event hash and the second event hash is verified in operation S750.

Because the second event hash is a value calculated by applying the combination of the first event hash and the second event data to the hash function, when the first hash value and the second hash value match each other, it is verified that the second event has occurred after the first event.

For example, the first event, the second event, and a third event may occur with the lapse of time. The second event hash for the second event may be calculated based on the first event hash for the first event that occurred previously. The second event hash may be calculated by using the hash function with the combination of the first event hash and the second event data as an input value. The calculated second event hash may be the same as the second event hash stored in the memory. The first hash value may be the same as the second hash value. The second event hash is a value calculated based on the first event hash, and when the first hash value stored in the memory and the recalculated second hash value are the same, the game providing apparatus may determine that the sequentiality of the first event hash and the second event hash is verified.

In another example, when the second event hash value has been calculated based on a third event hash for the third event having occurred after the second event, the calculated second event hash value may be different from the stored second event hash value. The first hash value and the second hash value may be different from each other. Accordingly, the game providing apparatus may determine that the sequentiality of the third event and the second event is not verified and an order thereof has been falsified.

When the first hash value and the second hash value do not match each other, the game providing apparatus may recover data, in operation S760.

According to an embodiment, the game providing apparatus may determine that pieces of data related to an event have been falsified and recover pieces of data related to the event and state. The game providing apparatus may repeat operations S710 to S740 after recovering the data.

According to an embodiment, when it is determined that the first hash value and the second hash value match each other as a result of repeating operations S710 and S740, and thus, the sequentiality of the first event hash and the second event hash is verified, the game providing apparatus may end an operation.

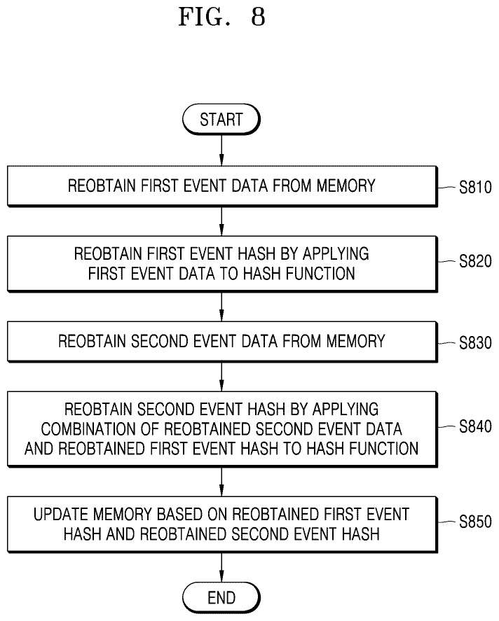

A process of recovering data will be described in detail below with reference to FIG. 8.

FIG. 8 is a flowchart of a method of recovering data when an event has been falsified, according to an embodiment. For convenience of description, details that overlap those described with reference to FIG. 3 will be briefly described or not be provided.

Referring to FIG. 8, according to an embodiment, operation S760 of FIG. 7 of recovering the data may include operations S810 to S850.

In operation S810, the game providing apparatus may reobtain the first event data, from the memory.

According to an embodiment, the game providing apparatus may obtain a user input of generating the first event and obtain the first event data based on the obtained user input. The game providing apparatus may store the obtained first event data in the memory. The game providing apparatus may reobtain the first event data from the memory.

In operation S820, the game providing apparatus may reobtain the first event hash by applying the first event data to the hash function. A method of calculating the first event hash is the same as that described with reference to operation S320 of FIG. 3, and thus will be briefly described.

According to an embodiment, the game providing apparatus may obtain, as input values, a list of values of pieces of information included in the first event data. The game providing apparatus may reobtain the first event hash by applying the obtained input values to the hash function.

In operation S830, the game providing apparatus may reobtain the second event data from the memory.

According to an embodiment, the game providing apparatus may obtain a user input of generating the second event and obtain the second event data based on the obtained user input. The game providing apparatus may store the obtained second event data in the memory. The game providing apparatus may reobtain the second event data from the memory.

In operation S840, the game providing apparatus may reobtain the second event hash by applying a combination of the reobtained second event data and the reobtained first event hash to the hash function. A method of calculating the second event hash is the same as that described with reference to operation S340 of FIG. 3, and thus will be briefly described.

According to an embodiment, the game providing apparatus may obtain, as input values, a list of values of pieces of information included in the second event data and the first event hash. The game providing apparatus may reobtain the second event hash by applying the obtained input values to the hash function.

In operation S850, the game providing apparatus may update the memory based on the reobtained first event hash and the reobtained second event hash.

According to an embodiment, the game providing apparatus may update the stored first event hash and second event hash to the reobtained first event hash and the reobtained second event hash. For example, the game providing apparatus may delete the stored first event hash and second event hash and store the reobtained first event hash and second event hash. In another example, the game providing apparatus may add the reobtained first event hash and second event hash to the memory.

According to an embodiment, the game providing apparatus may obtain pieces of event data for a plurality of events stored in the memory and reobtain an event hash based on the obtained pieces of event data. The game providing apparatus may update the memory based on the obtained event hash.

After operations S810 to S850 are completed, operation S710 of FIG. 7 may be performed again. When it is determined that the first hash value and the second hash value match each other after repeating operations S710 to S740 of FIG. 7, the game providing apparatus may determine that the sequentiality of the first event hash and the second event hash is verified.

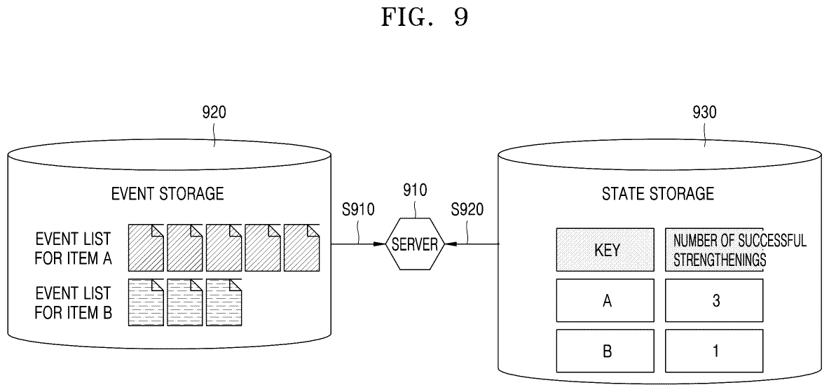

FIG. 9 is a conceptual diagram for describing the memory storing off-chain data, according to an embodiment.

Referring to FIG. 9, according to an embodiment, the game providing apparatus may include the memory including an event storage 920 and a state storage 930. The game providing apparatus may store event data related to an event in the event storage 920 and store state data related to a state in the state storage 930.

For example, the event storage 920 may store event lists for an item A and an item B. The event storage 920 may store sequential event lists for items and store the same as first event data and a first event hash. In detail, first event data, second event data, and third event data may be stored in the event storage 920 for the item A.

For example, the state storage 930 may store a result (or a state) according to the occurrence of an event. The state storage 930 may store data indicating the result according to the occurrence of event, and in detail, for example, may store, as the data, values representing a key for distinguishing an object, and a property, a type, and the like of the object. In FIG. 9, the number of successful strengthenings as an example, but data representing the property, type, and the like of the object is not limited thereto.

A current state of the item A may be recorded in the state storage 930, as a state in which strengthening has been successful three times, based on a key value of “A” and data about the number of successful strengthenings of “3”.

According to an embodiment, the game providing apparatus may generate event data according to event occurrence and store pieces of event data in the event storage 920. The game providing apparatus may generate and store pieces of event data for each object.

In operation S910, according to an embodiment, the game providing apparatus may obtain and read event data stored in the event storage 920.

In operation S920, according to an embodiment, the game providing apparatus may generate state data based on the event data. The state data may denote information about a current state/state/result changed according to the event occurrence. The game providing apparatus may store the generated state data in the state storage 930. The game providing apparatus may update a current state recorded in the state storage 930, based on the generated state data.

For example, event data related to successful strengthening of the item A may be generated. The game providing apparatus may obtain, based on the generated event data, state data of “key=A” and “number of successful strengthenings=+1”. The game providing apparatus may update the current state recorded in the state storage 930, based on the obtained state data. The game providing apparatus may update, based on the obtained state data, the current state to “key=A” and “number of successful strengthenings=3”.

Operations S910 and S920 may be performed by a separate server 910, but the technical scope of the disclosure is not limited thereto.

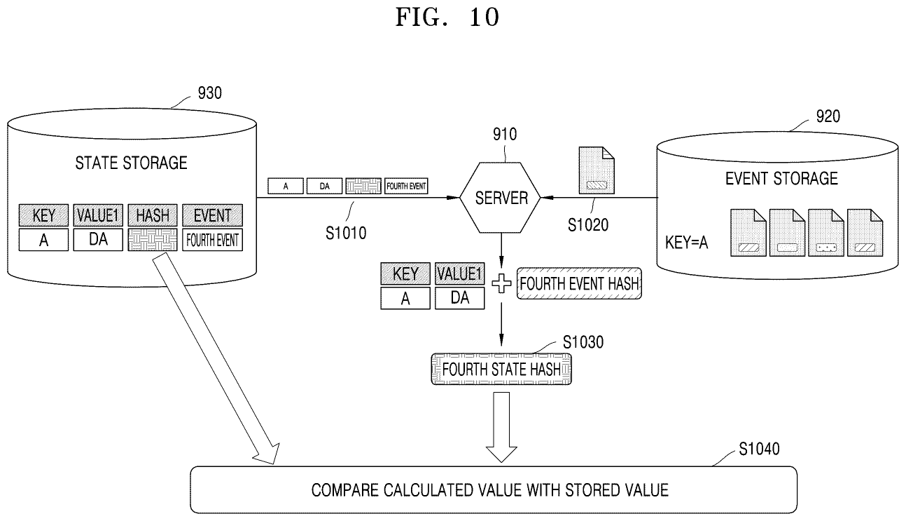

FIG. 10 is a diagram for describing a method of verifying the causality between an event and a state, based on stored off-chain data, according to an embodiment. For convenience of description, details that overlap those described with reference to FIG. 5 are not be provided.

Referring to FIG. 10, according to an embodiment, the game providing apparatus may verify the causality between an event and a state by verifying that a state hash has not been falsified. The game providing apparatus may calculate a state hash value to be compared to verify the causality between an event and a state.

According to an embodiment, the game providing apparatus may obtain, from the memory, a stored state hash value to be compared to verify the causality between an event and a state. The stored state hash value may be a hash value calculated by applying state data to a hash function, the state data being updated based on event data and event hash stored in the memory when an event occurs.

For example, the game providing apparatus may obtain a fourth state hash stored in the state storage 930. The stored fourth state hash may be a hash value generated based on a combination of a fourth event hash and a fourth state data and pre-stored in the state storage 930.

According to an embodiment, the game providing apparatus may newly calculate the state hash to be compared to verify the causality between the event and the state, based on the stored event hash and the stored state data. The game providing apparatus may obtain the state hash calculated based on the data stored in the memory.

For example, in operation S1010, the game providing apparatus may obtain, from the state storage 930, the pre-stored state data and state hash. In detail, the game providing apparatus may obtain the fourth state data from the state storage 930. The fourth state data may include information about a key and a value 1. The value 1 may include information about a type, a current state, and the like of an object, and does not limit the technical scope of the disclosure.

In operation S1020, the game providing apparatus may obtain the pre-stored event hash from the event storage 920. For example, the game providing apparatus may obtain the fourth event hash from the event storage 920.

According to an embodiment, the fourth event hash may be a hash value calculated by applying a combination of the third event hash and fourth event data to the hash function.

In operation S1030, the game providing apparatus may newly calculate the fourth state hash by applying a combination of the stored fourth state data and the stored fourth event hash to the hash function.

In operation S1040, the game providing apparatus may verify the causality between the event and the state by comparing the fourth state hash pre-stored in the state storage 930 with the newly calculated fourth state hash to determine whether they match each other.

According to an embodiment, a method of calculating the fourth state hash according to operations S1010 to S1030 may be the same as a method of calculating the fourth state hash stored in the state storage 930. However, because the fourth state hash is a hash value calculated based on the fourth event hash, a value of the fourth state hash may change when the fourth event hash is changed due to falsification of the fourth event. Accordingly, when the fourth event is falsified, the newly calculated fourth state hash may be different from the stored fourth state hash, and thus, the game providing apparatus may identify that the causality between the event and the state has been falsified.

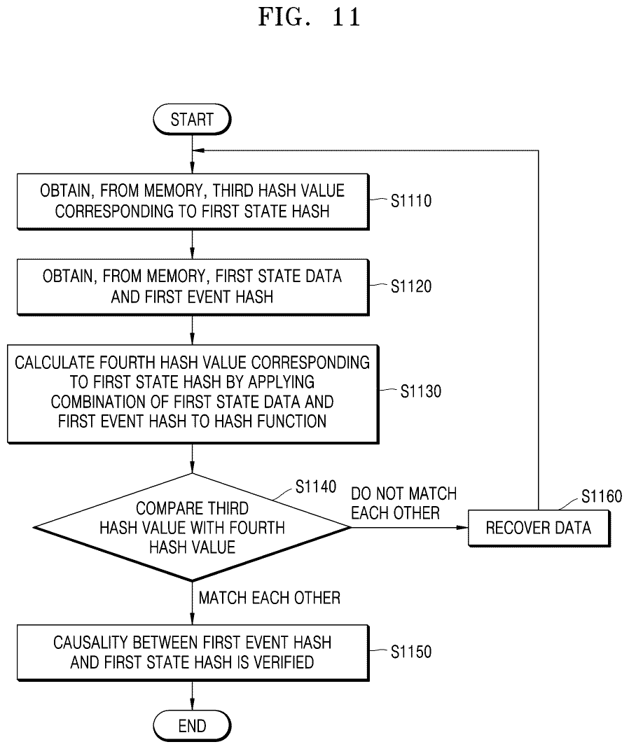

FIG. 11 is a flowchart of a method of verifying the causality between an event and a state, based on stored off-chain data, according to an embodiment. For convenience of description, details that overlap those described with reference to FIG. 10 will be briefly described or not be provided.

Referring to FIG. 11, in operation S1110, the game providing apparatus may obtain, from the memory, a third hash value corresponding to a first state hash.

According to an embodiment, the game providing apparatus may generate first state data based on a first event data when a first event occurs. Also, the game providing apparatus may generate a first event hash based on the first event data when the first event occurs. The game providing apparatus may store each of the first state data and the first event hash in the memory. The game providing apparatus may store, in the memory, a first state hash calculated based on the first state data and the first event hash.

According to an embodiment, the game providing apparatus may obtain the first state hash stored in the memory. The game providing apparatus may obtain the third hash value corresponding to the first state hash. The third hash value may denote a value of the first state hash that was stored in the memory. According to an embodiment, the first state hash may be a value calculated by applying a combination of the first state data and the first event hash to a hash function.

In operation S1120, the game providing apparatus may obtain, from the memory, the first state data and the first event hash. The game providing apparatus may obtain the first state data and the first event hash, which are pre-stored in the memory.

In operation S1130, the game providing apparatus may calculate a fourth hash value corresponding to the first state hash by applying the combination of the first state data and the first event hash to the hash function. The game providing apparatus may recalculate the first state hash based on the combination of the first state data and the first event hash, stored in the memory. The game providing apparatus may obtain the recalculated first state hash as the fourth hash value.

In operation S1140, the game providing apparatus may compare the third hash value with the fourth hash value.

According to an embodiment, the third hash value may be a value corresponding to the first state hash stored in the memory. The game providing apparatus may obtain, from the memory, the third hash value corresponding to the stored first state hash.

According to an embodiment, the fourth hash value may be a value of the first state hash recalculated based on the first state data and the first event hash, stored in the memory. The game providing apparatus may obtain, from the memory, the stored first state data and first event hash, and recalculate the first state hash based on the first state data and first event hash.

According to an embodiment, the game providing apparatus may compare the stored third hash value with the recalculated fourth hash value. The game providing apparatus may determine whether the third hash value and the fourth hash value match each other.

When the third hash value and the fourth hash value match each other, the game providing apparatus may determine that the causality of the first event hash and the first state hash is verified in operation S1150.

Because the first state hash is a hash value calculated by applying the combination of the first event hash and the first state data to the hash function, when the third hash value and the fourth hash value match each other, it is verified that a first state has occurred due to the first event.

For example, the first state may be determined as a result with the first event as a cause. The first state hash for the first state may be calculated based on the first event hash for the first event. The first state hash may be calculated by using the hash function with the combination of the first event hash and the first state data as an input value. The calculated first state hash may be the same as the first state hash stored in the memory. The third hash value may be the same as the fourth hash value. The game providing apparatus may determine that the causality of the first event hash and the first state hash is verified.

In another example, when the stored first state hash is a value calculated based on the second event hash, the calculated first state hash may be different from the stored first state hash value. The third hash value may be different from the fourth hash value. Accordingly, the game providing apparatus may determine that the first state is not occurred due to the first event. The causality of the first event and the first state is not verified and it may be determined that a causal relationship thereof has been falsified.

When the third hash value and the fourth hash value do not match each other, the game providing apparatus may recover data in operation S1160.

According to an embodiment, the game providing apparatus may determine that pieces of data related to an event or a state have been falsified and recover the pieces of data related to the event and state. The game providing apparatus may repeat operations S1110 to S1140 after recovering the data.

According to an embodiment, when it is determined that the third hash value and the fourth hash value match each other as a result of repeating operations S1110 and S1140, and thus, the causality of the first event hash and the first state hash is verified, the game providing apparatus may end an operation.

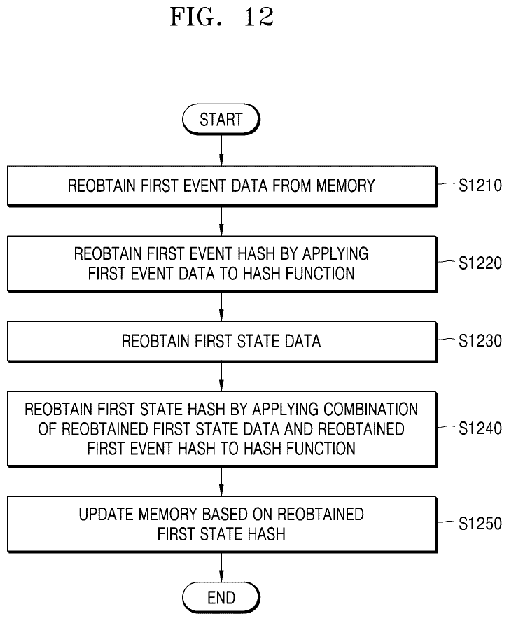

A process of recovering data will be described in detail below with reference to FIG. 12.

FIG. 12 is a flowchart of a method of recovering data when an event or a state has been falsified, according to an embodiment. For convenience of description, details that overlap those described with reference to FIG. 3 will be briefly described or omitted.

Referring to FIG. 12, according to an embodiment, operation S1160 of FIG. 11 of recovering the data may include operations S1210 to S1250.

In operation S1210, the game providing apparatus may reobtain the first event data, from the memory.

According to an embodiment, the game providing apparatus may obtain a user input of generating the first event and obtain the first event data based on the obtained user input. The game providing apparatus may store the obtained first event data in the memory. The game providing apparatus may reobtain the first event data from the memory.

In operation S1220, the game providing apparatus may reobtain the first event hash by applying the first event data to the hash function. A method of calculating the first event hash is the same as that described with reference to operation S320 of FIG. 3, and thus will be briefly described.

According to an embodiment, the game providing apparatus may obtain, as input values, a list of values of pieces of information included in the first event data. The game providing apparatus may reobtain the first event hash by applying the obtained input values to the hash function.

In operation S1230, the game providing apparatus may reobtain the first state data by reproducing the first event data. The game providing apparatus may reobtain the first state data related to the first state that is a result according to the occurrence of the first event.

In operation S1240, the game providing apparatus may reobtain the first state hash by applying a combination of the reobtained first state data and the reobtained first event hash to the hash function. A method of calculating the first state hash is the same as that described with reference to FIG. 5, and thus will be briefly described.

According to an embodiment, the game providing apparatus may obtain, as input values, a list of values of pieces of information included in the first state data and the first event hash. The game providing apparatus may reobtain the first state hash by applying the obtained input values to the hash function.

In operation S1250, the game providing apparatus may update the memory based on the reobtained first state hash.

According to an embodiment, the game providing apparatus may update the stored first event hash and first state hash to the reobtained first event hash and the reobtained first state hash. For example, the game providing apparatus may delete the stored first event hash and first state hash and store the reobtained first event hash and first state hash. In another example, the game providing apparatus may add the reobtained first event hash and first state hash to the memory.

According to an embodiment, the game providing apparatus may obtain pieces of event data for a plurality of events stored in the memory and reobtain an event hash based on the obtained pieces of event data, and state data and state hash for a final state. The game providing apparatus may update the memory based on the obtained event hash and the state data and state hash for the final state.

After operations S1210 to S1250 are completed, operation S1110 of FIG. 11 may be performed again. When it is determined that the third hash value and the fourth hash value match each other after repeating operations S1110 to S1140 of FIG. 11, the game providing apparatus may determine that the causality of the first event hash and the first state hash is verified.

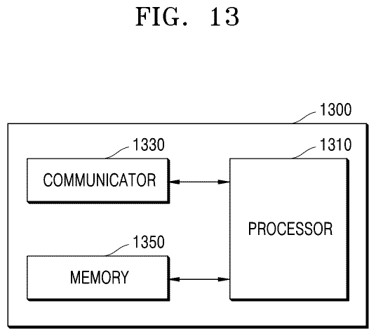

FIG. 13 is a diagram for describing a specific configuration of a game providing apparatus 1300, according to some embodiments.

As shown in FIG. 13 the game providing apparatus 1300 according to some embodiments may include at least one processor 1310, a communicator 1330, and a memory 1350. However, the components shown in FIG. 13 are not all essential components of the game providing apparatus 1300. The game providing apparatus 1300 may include more or fewer components than those shown in FIG. 13. The game providing apparatus 130 may be a user terminal, a server, a game network system, or a separate device.

According to an embodiment, the processor 1310 may generally control all operations of the game providing apparatus 1300. For example, the processor 1310 may execute a program stored in the memory 1350 to control the communicator 1330 and the memory 1350 in general. The processor 1310 may control operations of the game providing apparatus 1300 of the present specification by controlling the communicator 1330 and the memory 1350.

According to an embodiment, the memory 1350 may store instructions. The processor 1310 may be functionally connected to the memory 1350 and control general operations of the game providing apparatus 1300 by executing the instructions stored in the memory 1350.

According to an embodiment, the processor 1310 may obtain first event data related to a first event having occurred in a game service. The processor 1310 may obtain a first event hash by applying the first event data to a hash function. The processor 1310 may obtain second event data related to a second event having occurred in the game service after the first event. The processor 1310 may obtain the second event hash by applying a combination of the second event data and the first event hash to the hash function.

According to an embodiment, the processor 1310 may obtain, from the memory 1350, a first hash value corresponding to the second event hash. The processor 1310 may obtain, from the memory 1350, the second event data and the first event hash. The processor 1310 may calculate a second hash value corresponding to the second event hash by applying the combination of the second event data and the first event hash to the hash function. The processor 1310 may compare the first hash value with the second hash value. The processor 1310 may verify the sequentiality of the first event hash and the second event hash, based on a result of the comparison.

According to an embodiment, the first event data and the second event data may each include information about at least one of a change, a name, a type, an identifier, an owner, and an event occurrence date of an object in the game service, the object being affected by an event occurrence.

According to an embodiment, the processor 1310 may obtain first state data related to a first state that is a result according to the occurrence of the first event, and obtain a first state hash by applying a combination of the first state data and the first event hash to the hash function.

According to an embodiment, the processor 1310 may obtain second state data related to a second state that is a result according to the occurrence of a second event, and obtain a second state hash by applying a combination of the second state data and the second event hash to the hash function. The second event hash may be obtained by applying a combination of the second event data and the first event hash to the hash function.

According to an embodiment, the processor 1310 may obtain the first event data related to the first event having occurred in the game service, and the first state data related to the first state that is the result according to the occurrence of the first event. The processor 1310 may obtain the first event hash by applying the first event data to the hash function. The processor 1310 may obtain the first state hash by applying the combination of the first state data and the first event hash to the hash function.

According to an embodiment, when the first hash value and the second hash value do not match each other, based on the result of the comparison, the processor 1310 may reobtain the first event data from the memory 1350, reobtain the first event hash by applying the first event data to the hash function, reobtain the second event data from the memory 1350, reobtain the second event hash by applying a combination of the reobtained second event data and the reobtained first event hash to the hash function, and update the memory 1350 based on the reobtained first event hash and the reobtained second event hash.

According to an embodiment, the processor 1310 may obtain, from the memory 1350, a third hash value corresponding to the first state hash. The processor 1310 may obtain, from the memory 1350, the first state data and the first event hash. The processor 1310 may obtain a fourth hash value corresponding to the first state hash by applying the combination of the first state data and the first event hash to the hash function. The processor 1310 may compare the third hash value with the fourth hash value. The processor 1310 may verify the causality of the first event hash and the first state hash, based on a result of the comparison.

According to an embodiment, when the third hash value and the fourth hash value do not match each other, based on the result of the comparison, the processor 1310 may reobtain the first event data from the memory 1350, reobtain the first event hash by applying the first event data to the hash function, reobtain the first state data from the memory 1350, reobtain the first state hash by applying a combination of the reobtained first state data and the reobtained first event hash to the hash function, and update the memory 1350 based on the reobtained first state hash.

According to an embodiment, the communicator 1330 may perform communication with an external device under control by the processor 1310. For example, the communicator 1330 may perform communication with the external device, such as a payment server or an authentication server, under control by the processor 1310. Also, the communicator 1330 may obtain user information or a user input through communication with an external interface.

According to an embodiment, the processor 1310 may obtain a user input of generating an event, from a separate user terminal through the communicator 1330. The processor 1310 may generate event data based on the obtained user input or calculate an event hash based on the event data. Some or all of operations of the user terminal may be performed by the game providing apparatus 1300. For example, the game providing apparatus 1300 may directly obtain a user input without having to communicate with a separate user terminal.

The memory 1350 may store programs for processes and controls by the processor 1310 and may store data input to or output from the game providing apparatus 1300. According to an embodiment, the memory 1350 may store an event storage and a state storage.

According to an embodiment, the event storage may store event data and event hash related to an event having occurred in a game service. The state storage may store state data and state hash related to a state that is a result according to the occurrence of an event.

According to an embodiment, data stored in the event storage may be impossible to be changed or deleted. Only addition and reading of data may be possible in the event storage. According to an embodiment, data stored in the state storage may be added, read, changed, or deleted.

According to an embodiment, the processor 1310 may execute a method of providing a game service by using the program stored in the memory 1350. For example, the processor 1310 may store, in the memory 1350, the second event hash calculated in consideration of the first event hash. The game providing apparatus 1300 may verify the sequentiality of the first event and the second event through the first event hash and the second event hash. In another example, the processor 1310 may store, in the memory 1350, the first state hash calculated in consideration of the first event hash. The game providing apparatus 1300 may verify the causality of the first event and the first state through the first event hash and the first state hash.

According to an embodiment, the memory 1350 may include at least one type of storage medium among a flash memory type, a hard disk type, a multimedia card micro type, a card type memory (for example, a secure digital (SD) or an extreme digital (XD) memory), a random-access memory (RAM), a static RAM (SRAM), a read-only memory (ROM), an electrically erasable programmable ROM (EEPROM), a programmable ROM (PROM), a magnetic memory, a magnetic disk, and an optical disk. Also, according to an embodiment, the programs stored in the memory 1350 may be classified into a plurality of modules according to functions.

According to an embodiment, the method of providing a game service may be performed by the game providing apparatus 1300, a server, or a user terminal, and at least one component included in the game providing apparatus 1300 may perform embodiments described above with reference to FIGS. 1 to 13.

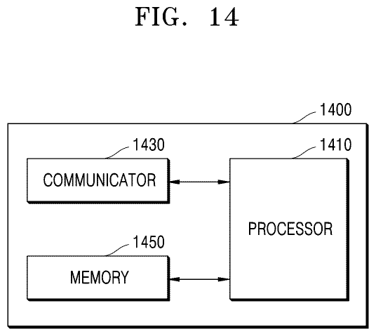

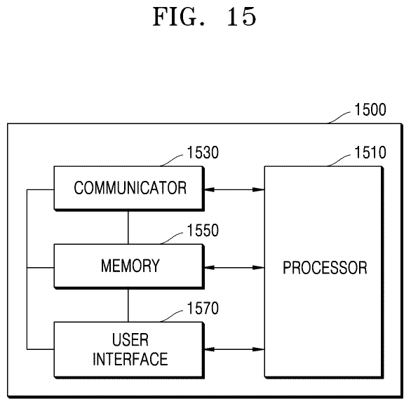

The method of providing a game service may be performed by the server and the user terminal individually or together. Configurations of the server and the user terminal will be described in further detail below with reference to FIGS. 14 and 15.

FIG. 14 is a diagram for describing a specific configuration of a server 1400, according to some embodiments.

As shown in FIG. 14, the server 1400 according to some embodiments may include at least one processor 1410, a communicator 1430, and a memory 1450. However, the components shown in FIG. 14 are not all essential components of the server 1400. The server 1400 may include more or fewer components than those shown in FIG. 14.

According to an embodiment, the processor 1410 may generally control all operations of the server 1400. For example, the processor 1410 may execute a program stored in the memory 1450 to control the communicator 1430 and the memory 1450 in general. The processor 1410 may control operations of the server 1400 of the present specification by controlling the communicator 1430 and the memory 1450.

According to an embodiment, the processor 1410 may obtain first event data related to a first event having occurred in a game service. The processor 1410 may obtain a first event hash by applying the first event data to a hash function. The processor 1410 may obtain second event data related to a second event having occurred in the game service after the first event. The processor 1410 may obtain a second event hash by applying a combination of the second event data and the first event hash to the hash function.

According to an embodiment, operations of the processor 1410 may correspond to operations of the processor 1310 of the game providing apparatus 1300, described with reference to FIG. 13, and thus detailed descriptions thereof are omitted.

The communicator 1430 may provide an inquiry to a user terminal 1500 of FIG. 15 under control by the processor 1410 and receive response information to the inquiry. Also, according to an embodiment, the communicator 1430 may transmit or receive data to or from the user terminal 1500, and the data transmitted or received to or from the user terminal 1500 may include control data for controlling the user terminal 1500 or a program included in the user terminal 1500.

The memory 1450 may store programs for processes and controls by the processor 1410 and may store data input to or output from the server 1400. According to an embodiment, the memory 1450 may store event data and event hash related to an event having occurred in a game service, and store state data and state hash related to a state that is a result according to the occurrence of the event.

According to an embodiment, the processor 1410 may execute a method of providing a game service by using the program stored in the memory 1450.

According to an embodiment, the memory 1450 may include at least one type of storage medium among a flash memory type, a hard disk type, a multimedia card micro type, a card type memory (for example, a secure digital (SD) or an extreme digital (XD) memory), a random-access memory (RAM), a static RAM (SRAM), a read-only memory (ROM), an electrically erasable programmable ROM (EEPROM), a programmable ROM (PROM), a magnetic memory, a magnetic disk, and an optical disk. Also, according to an embodiment, the programs stored in the memory 1450 may be classified into a plurality of modules according to functions.

According to an embodiment, the method of providing a game service may be performed dividedly by the server 1400 and the user terminal 1500, performed individually by the server 1400 and the user terminal 1500, or performed by the game providing apparatus 1300.

FIG. 15 is a diagram for describing a specific configuration of the user terminal 1500, according to some embodiments.

As shown in FIG. 15, the user terminal 1500 according to some embodiments may include at least one processor 1510, a communicator 1530, a memory 1550, and a user interface 1570. However, the components shown in FIG. 15 are not all essential components of the user terminal 1500. The user terminal 1500 may include more or fewer components than those shown in FIG. 15.

According to an embodiment, the processor 1510 may generally control all operations of the user terminal 1500. For example, the processor 1510 may execute a program stored in the memory 1550 to control the communicator 1530, the memory 1550, and the user interface 1570 in general. The processor 1510 may control operations of the user terminal 1500 of the present specification by controlling the communicator 1530, the memory 1550, and the user interface 1570.

According to an embodiment, the processor 1510 may obtain first event data related to a first event having occurred in a game service. The processor 1510 may obtain a first event hash by applying the first event data to a hash function. The processor 1510 may obtain second event data related to a second event having occurred in the game service after the first event. The processor 1510 may obtain a second event hash by applying a combination of the second event data and the first event hash to the hash function.

According to an embodiment, operations of the processor 1510 may correspond to operations of the processor 1310 of the game providing apparatus 1300, described with reference to FIG. 13, and thus detailed descriptions thereof are omitted.

The communicator 1530 may provide an inquiry to the server 1400 under control by the processor 1510 and receive response information to the inquiry. Also, according to an embodiment, the communicator 1530 may transmit or receive data to or from the server 1400, and the data transmitted or received to or from the server 1400 may include control data for controlling the user terminal 1500 or a program included in the user terminal 1500.

According to an embodiment, the communicator 1530 may include a Bluetooth communicator, a Bluetooth low energy (BLE) communicator, a near field communicator, a wireless local area network (WLAN) (Wi-Fi) communicator, a ZigBee communicator, an infrared data association (IrDA) communicator, a Wi-Fi direct (WFD) communicator, an ultra-wideband (UWB) communicator, or an Ant+ communicator, but is not limited thereto.

According to an embodiment, the communicator 1530 transmits or receives a wireless signal to or from at least one of a base station, an external terminal, and a server, on a mobile communication network. Here, the wireless signal may include various types of data according to exchange of a voice call signal, an image call signal, or a text/multimedia message.

The memory 1550 may store programs for processes and controls by the processor 1510 and may store data input to or output from the user terminal 1500. According to an embodiment, the memory 1550 may store event data and event hash related to an event having occurred in a game service, and store state data and state hash related to a state that is a result according to the occurrence of the event.

According to an embodiment, the processor 1510 may execute a method of providing a game service by using the program stored in the memory 1550.

According to an embodiment, the memory 1550 may include at least one type of storage medium among a flash memory type, a hard disk type, a multimedia card micro type, a card type memory (for example, a secure digital (SD) or an extreme digital (XD) memory), a random-access memory (RAM), a static RAM (SRAM), a read-only memory (ROM), an electrically erasable programmable ROM (EEPROM), a programmable ROM (PROM), a magnetic memory, a magnetic disk, and an optical disk. Also, according to an embodiment, the programs stored in the memory 1550 may be classified into a plurality of modules according to functions.

According to an embodiment, the user interface 1570 may include various interfaces. For example, the user interface 1570 may include any interface, such as a key pad, a dome switch, a speech input interface, a fingerprint input interface, and a touch input interface (contact capacitive type, pressure resistive type, infrared detection type, surface ultrasonic conduction type, integrated tension measurement type, or piezo-effect type), a camera, a jog wheel, or a jog switch, and may be link any sensor, such as an acceleration sensor, a position sensor, a temperature sensor, or an optical sensor to a user interface. Obviously, the disclosure is not limited to the above examples.

According to an embodiment, the user interface 1570 may further include an output unit (not shown). The output unit may include at least one of a liquid crystal display, a thin-film transistor-liquid crystal display, an organic light-emitting diode, a flexible display, a 3-dimensional (3D) display, and an electrophoretic display. When the output unit is configured as a touch screen as a display and a touch pad form a layer structure, the output unit may be used as an input device as well as an output device. The output unit may include a light-emitting diode (LED) lamp, a vibration motor, a speaker, or a flash, but is not limited thereto.

According to an embodiment, the user interface 1570 may output a notification about game information through an image, a moving image, sound, vibration, or a lamp.

The apparatus described above may be realized by a hardware component, a software component, and/or a combination of a hardware component and a software component. For example, the apparatus and component described in embodiments may be realized by using one or more general-purpose computers or special purpose computers, such as a processor, a controller, an arithmetic logic unit (ALU), a digital signal processor, a micro-computer, a field programmable gate array (FPGA), a programmable logic unit (PLU), a micro-processor, or any other device capable of executing and responding to an instruction. A processing device may execute an operating system (OS) and one or more software applications executed on the OS. Also, the processing device may access, store, manipulate, process, and generate data in response to execution of software. For convenience of description, it has been described that one processing device is used, but it would be obvious to one of ordinary skill in the art that the processing device may include a plurality of processing elements and/or a plurality of types of processing elements. For example, the processing device may include a plurality of processors or one processor and one controller. Also, another processing configuration, such as a parallel processor, is possible.

The software may include a computer program, a code, an instruction, or a combination thereof, and may configure the processing device to operate as desired or instruct the processing device independently or collectively. The software and/or data may be embodied, permanently or temporarily, by any type of machine, component, physical device, virtual equipment, computer storage medium or device, or transmitted signal wave, such as to be analyzed by the processing device or provided to the processing device. The software may be distributed on a computer system connected to a network, and stored or executed in a distributed manner. The software and data may be stored in one or more computer-readable recording media.

Methods according to embodiments may be recorded on a computer-readable recording medium by being implemented in the form of program commands executed by using various computers. The computer-readable recording medium may include at least one of a program command, a data file, and a data structure, independently or collectively. The program commands recorded in the computer-readable recording medium may be specially designed for an embodiment or well known to one of ordinary skill in the computer software field. Examples of the computer-readable recording medium include magnetic media such as hard disks, floppy disks, and magnetic tapes, optical media such as CD-ROMs and DVDs, magneto-optical media such as floptical disks, and hardware devices specially configured to store and perform program commands, such as read-only memory (ROM), random-access memory (RAM), and flash memory. Examples of the computer command include machine codes generated by a compiler, and high-level language codes executable by a computer by using an interpreter. The hardware device may be configured to operate as one or more software modules to perform operations of an embodiment, or vice versa.

Through some embodiments, security and transparency may be improved with respect to managing data in a game service.

As above, embodiments have been described by the limited examples and drawings, but various changes and modifications are possible from the above description by one of ordinary skill in the art. For example, appropriate results may be achieved even when the described techniques are performed in an order different from the described method, and/or components, such as a system, a structure, a device, and a circuit, are combined or associated in a form different from the described method, or replaced by other components or equivalents.

Therefore, other implementations, other embodiments, and equivalents of claims are also within the scope of the disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, performed by a game providing apparatus, of managing game data, the method comprising:
obtaining first event data related to a first event having occurred in a game service;
obtaining a first event hash by applying the first event data to a hash function;
obtaining second event data related to a second event having occurred in the game service after the first event; and
obtaining a second event hash by applying a combination of the second event data and the first event hash to the hash function.

2. The method of claim 1, wherein the obtaining of the first event data comprises:
storing, in a memory, the first event data generated according to an occurrence of the first event; and
obtaining the stored first event data from the memory.

3. The method of claim 1, wherein the first event data and the second event data each comprise information about at least one of a change, a name, a type, an identifier, an owner, and an event occurrence date of an object in the game service, the object being affected by an event occurrence.

4. The method of claim 1, wherein the combination of the second event data and the first event hash is determined by a sequential input of the second event data and the first event hash.

5. The method of claim 1, further comprising:
obtaining first state data related to a first state that is a result according to an occurrence of the first event; and
obtaining a first state hash by applying a combination of the first state data and the first event hash to the hash function.

6. The method of claim 1, further comprising:
obtaining second state data related to a second state that is a result according to an occurrence of the second event; and
obtaining a second state hash by applying a combination of the second state data and the second event hash to the hash function,
wherein the second event hash is obtained by applying a combination of the second event data and the first event hash to the hash function.

7. The method of claim 1, further comprising:
obtaining, from a memory, a first hash value corresponding to the second event hash;
obtaining, from the memory, the second event data and the first event hash;
calculating a second hash value corresponding to the second event hash by applying the combination of the second event data and the first event hash to the hash function;
comparing the first hash value with the second hash value; and
verifying the sequentiality of the first event hash and the second event hash, based on a result of the comparing.

8. The method of claim 7, further comprising, according to the first hash value and the second hash value not corresponding to each other, based on the result of the comparing:
reobtaining the first event data from the memory;
reobtaining the first event hash by applying the first event data to the hash function;
reobtaining the second event data from the memory;
reobtaining the second event hash by applying a combination of the reobtained second event data and the reobtained first event hash to the hash function; and
updating the memory based on the reobtained first event hash and the reobtained second event hash.

9. The method of claim 5, further comprising:
obtaining, from a memory, a third hash value corresponding to the first state hash;
obtaining, from the memory, the first state data and the first event hash;
obtaining a fourth hash value corresponding to the first event hash by applying the combination of the first state data and the first event hash to the hash function;
comparing the third hash value with the fourth hash value; and
verifying the causality of the first event hash and the first state hash, based on a result of the comparing.

10. The method of claim 9, further comprising, when the third hash value and the fourth hash value do not match each other, based on the result of the comparing:
reobtaining the first event data from the memory;
reobtaining the first event hash by applying the first event data to the hash function;
reobtaining the first state data from the memory;
reobtaining the first event hash by applying a combination of the reobtained first event data and the reobtained first event hash to the hash function; and
updating the memory based on the reobtained first state hash.

11. A method, performed by a game providing apparatus, of managing game data, the method comprising:
obtaining first event data related to a first event having occurred in a game service, and first state data related to a first state that is a result according to the occurrence of the first event;
obtaining a first event hash by applying the first event data to a hash function; and
obtaining a first state hash by applying a combination of the first state data and the first event hash to the hash function.

12. A game providing apparatus comprising:
a memory storing instructions; and
at least one processor functionally connected to the memory and configured to execute the instructions to:
obtain first event data related to a first event having occurred in a game service;
obtain a first event hash by applying the first event data to a hash function;
obtain second event data related to a second event having occurred in the game service after the first event; and
obtain a second event hash by applying a combination of the second event data and the first event hash to the hash function.

13. The game providing apparatus of claim 12, wherein the first event data and the second event data each comprise information about at least one of a change, a name, a type, an identifier, an owner, and an event occurrence date of an object in the game service, the object being affected by an event occurrence.

14. The game providing apparatus of claim 12, wherein the at least one processor is further configured to execute the instructions to:
obtain first state data related to a first state that is a result according to an occurrence of the first event; and
obtain a first state hash by applying a combination of the first state data and the first event hash to the hash function.

15. The game providing apparatus of claim 12, wherein the at least one processor is further configured to execute the instructions to:
obtain second state data related to a second state that is a result according to an occurrence of the second event; and
obtain a second state hash by applying a combination of the second state data and the second event hash to the hash function,
wherein the second event hash is obtained by applying a combination of the second event data and the first event hash to the hash function.

16. The game providing apparatus of claim 12, wherein the at least one processor is further configured to execute the instructions to:
obtain, from the memory, a first hash value corresponding to the second event hash;
obtain, from the memory, the second event data and the first event hash;
calculate a second hash value corresponding to the second event hash by applying the combination of the second event data and the first event hash to the hash function;
compare the first hash value with the second hash value; and
verify the sequentiality of the first event hash and the second event hash, based on a result of the comparison.

17. The game providing apparatus of claim 16, wherein, according to the first hash value and the second hash value not corresponding to each other, based on the result of the comparison,
the at least one processor is further configured to execute the instructions to:
reobtain the first event data from the memory;
reobtain the first event hash by applying the first event data to the hash function;
reobtain the second event data from the memory;
reobtain the second event hash by applying a combination of the reobtained second event data and the reobtained first event hash to the hash function; and
update the memory based on the reobtained first event hash and the reobtained second event hash.

18. The game providing apparatus of claim 14, wherein the at least one processor is further configured to execute the instructions to:
obtain, from the memory, a third hash value corresponding to the first state hash;
obtain, from the memory, the first state data and the first event hash;
obtain a fourth hash value corresponding to the first event hash by applying the combination of the first state data and the first event hash to the hash function;
compare the third hash value with the fourth hash value; and
verify the causality of the first event hash and the first state hash, based on a result of the comparison.

19. The game providing apparatus of claim 18, wherein, when the third hash value and the fourth hash value do not match each other, based on the result of the comparison,
the at least one processor is further configured to execute the instructions to:
reobtain the first event data from the memory;
reobtain the first event hash by applying the first event data to the hash function;
reobtain the first state data from the memory;
reobtain the first event hash by applying a combination of the reobtained first event data and the reobtained first event hash to the hash function; and
update the memory based on the reobtained first state hash.

20. A server comprising:
a memory storing instructions; and
at least one processor functionally connected to the memory and configured to execute the instructions to:
obtain first event data related to a first event having occurred in a game service;
obtain a first event hash by applying the first event data to a hash function;
obtain second event data related to a second event having occurred in the game service after the first event; and
obtain a second event hash by applying a combination of the second event data and the first event hash to the hash function.

21. A user terminal for providing a game service, the user terminal comprising:
a user input unit configured to receive a user input;
a memory storing instructions; and
at least one processor functionally connected to the user input unit and the memory, and configured to execute the instructions to:
obtain first event data related to a first event having occurred in the game service;
obtain a first event hash by applying the first event data to a hash function;
obtain second event data related to a second event having occurred in the game service after the first event; and
obtain a second event hash by applying a combination of the second event data and the first event hash to the hash function.

22. A computer-readable recording medium having recorded thereon a program for executing, on a computer, a method of managing game data, the method comprising:
obtaining first event data related to a first event having occurred in a game service;
obtaining a first event hash by applying the first event data to a hash function;
obtaining second event data related to a second event having occurred in the game service after the first event; and
obtaining a second event hash by applying a combination of the second event data and the first event hash to the hash function.
